(19) United States
(12) Patent Application Publication
(10) Pub. No.: US 2026/0219454 A1
(43) Pub. Date: Jul. 30, 2026

(54) OPTICAL MODULE

(71) Applicant: NEC Corporation, Tokyo (JP)

(72) Inventor: Morio TAKAHASHI, Tokyo (JP)

(73) Assignee: NEC Corporation, Tokyo (JP)

(21) Appl. No.: 19/151,695

(22) PCT Filed: Feb. 8, 2023
(86) PCT No.: PCT/JP2023/004102

§ 371 Date: Jul. 29, 2025

(51) Int. Cl. G02B 6/293

(52) U.S. Cl. CPC G02B 6/29338; G02B 6/29395

(57) ABSTRACT

The optical module includes: a first substrate (30); a second substrate (40) that is stacked on the first substrate (30); a ring resonator (10) that has an annular optical waveguide and is attached to the first substrate (30); a heater (20) that is provided inside a first region (R1) of which the outer periphery is the optical waveguide when viewed through the first substrate (30) from a direction perpendicular to the first substrate (30), the heater (20) being provided inside the first substrate (30) and heating the ring resonator (10); and a gap (50) that is located between the first substrate (30) and the second substrate (40) and is formed so that the first substrate (30) and the second substrate (40) are spaced away from each other within the first region (R1).

### TECHNICAL FIELD

The present invention relates to, for example, an optical module including a heater and a ring resonator.

### BACKGROUND ART

In optical communication, an optical waveguide ring resonator (also, simply referred to as a ring resonator) is used as an optical filter that processes light. An optical waveguide ring resonator is widely used as a tunable filter, an optical switch, and a modulator because the optical waveguide ring resonator can achieve a small and periodic transmission wavelength characteristic. The transmission wavelength of the optical waveguide ring resonator is determined by the ring length and the waveguide refractive index, and the wavelength tunability can be achieved by temperature control using a micro heater loaded in the optical waveguide.

PTL 1 discloses, for example, a heater (micro heater) provided in a ring resonator structure. In addition, PTL 2 discloses a film-shaped heater (micro heater) provided along a ring-shaped waveguide for wavelength tuning.

### CITATION LIST

### Patent Literature

PTL 1: JP 2022-061930 A
PTL 2: JP 2006-245344 A

### SUMMARY OF INVENTION

### Technical Problem

However, in a case where the micro heater is used, there is a problem that power consumption is large. For example, in PTL 1, since a ring resonator structure and a silicon on insulator (SOI) substrate are stacked, heat from the heater is easily transferred to the SOI substrate. Therefore, according to the technique disclosed in PTL 1, a part of the heat from the heater is also transferred to the SOI substrate, and the heat from the heater cannot be efficiently transferred to the ring resonator structure.

In view of the above-described problems, an object of the present invention is to enable efficient heat transfer to a ring resonator.

### Solution to Problem

According to the present invention, there is provided an optical module including:
a first substrate;
a second substrate stacked on the first substrate;
a ring resonator having a ring-shaped optical waveguide and attached to the first substrate;
a heater that is provided inside the first substrate and heats the ring resonator in a first region having the optical waveguide as an outer periphery when viewed through the first substrate from a direction perpendicular to a surface of the first substrate; and
a gap located between the first substrate and the second substrate and formed in such a way that the first substrate and the second substrate are spaced away from each other in the first region.

### Advantageous Effects of Invention

According to the present invention, it is possible to provide an optical module that efficiently transmits heat from a heater to a ring resonator.

### BRIEF DESCRIPTION OF DRAWINGS

FIG. 1 is a top view illustrating a configuration example of an optical module according to a first example embodiment of the present invention.

FIG. 2 is a cross-sectional view illustrating details of the optical module in the first example embodiment of the present invention.

FIG. 3 is a top view illustrating details of the optical module in the first example embodiment of the present invention.

FIG. 4 is a cross-sectional view illustrating details of the optical module in the first example embodiment of the present invention.

FIG. 5 is a cross-sectional view illustrating details of the optical module in the first example embodiment of the present invention.

FIG. 6 is a cross-sectional view illustrating details of the optical module according to the first example embodiment of the present invention.

FIG. 7 is a view illustrating a modification of the optical module in the first example embodiment of the present invention.

FIG. 8 is a view illustrating a modification of the optical module in the first example embodiment of the present invention.

FIG. 9 is a view illustrating a modification of the optical module in the first example embodiment of the present invention.

FIG. 10 is a top view illustrating a configuration example of an optical module according to a second example embodiment of the present invention.

FIG. 11 is a cross-sectional view illustrating details of the optical module in the second example embodiment of the present invention.

FIG. 12 is a cross-sectional view illustrating details of the optical module in the second example embodiment of the present invention.

### EXAMPLE EMBODIMENT

### First Example Embodiment

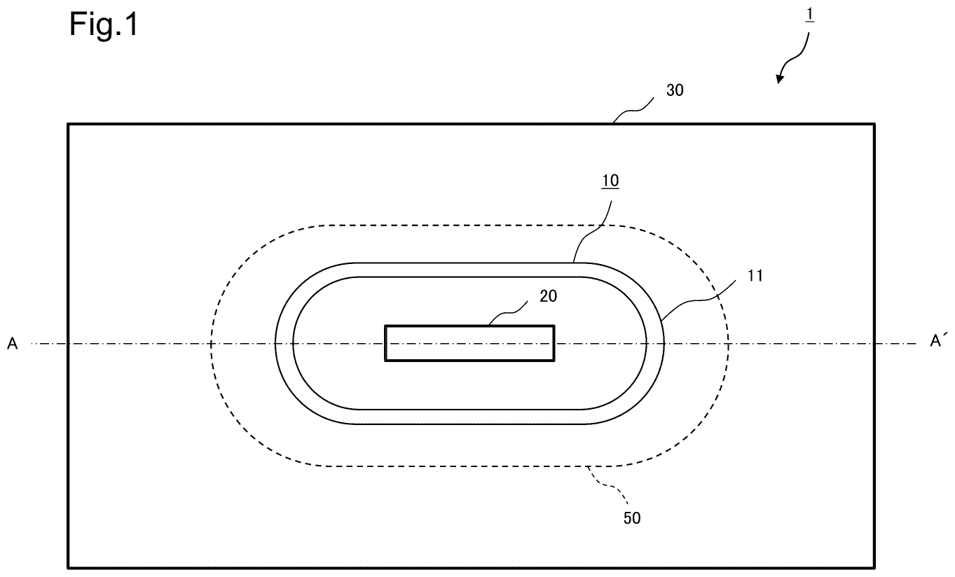

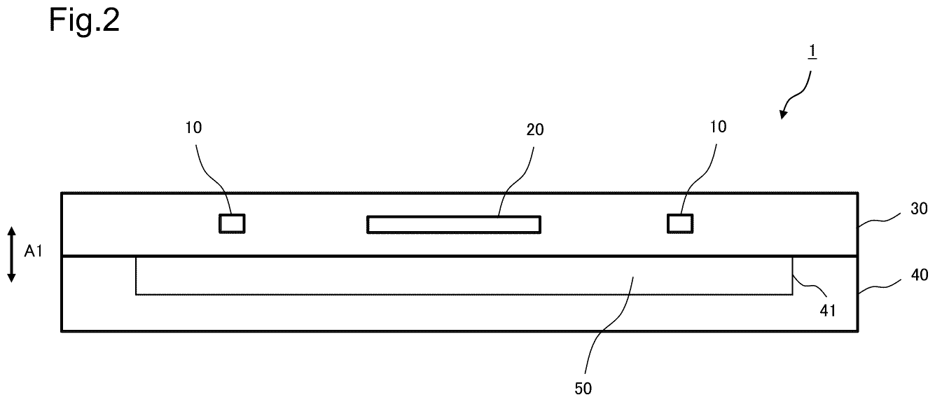

An optical module 1 in a first example embodiment will be described with reference to FIGS. 1 and 2. FIG. 1 is a transmission diagram illustrating a configuration example of the optical module 1. FIG. 2 is a cross-sectional view of the optical module 1. Specifically, FIG. 2 is a cross-sectional view of the optical module 1 taken along line A-A′ illustrated in FIG. 1.

As illustrated in FIG. 1, the optical module 1 includes a ring resonator 10, a heater 20, a first substrate 30, and a gap 50. As illustrated in FIG. 2, the optical module 1 includes the ring resonator 10, the heater 20, the first substrate 30, a second substrate 40, and the gap 50.

As illustrated in FIG. 1, the ring resonator 10 includes at least a ring-shaped optical waveguide 11. Light enters the ring-shaped optical waveguide 11 included in the ring resonator 10, and only light having a partial wavelength out of an incident light is output from the ring-shaped optical waveguide 11. A wavelength of the output light is determined by a length of the ring-shaped optical waveguide 11 and a refractive index of the optical waveguide. Although not illustrated in FIG. 1, the ring resonator 10 may further include a waveguide that guides light to enter the ring-shaped optical waveguide 11 and a waveguide that guides light output from the ring-shaped optical waveguide 11 to another optical element.

As illustrated in FIG. 1, the heater 20 is provided inside the ring-shaped optical waveguide 11 included in the ring resonator 10. Specifically, the heater 20 is provided inside the first substrate 30 in a first region having the ring-shaped optical waveguide 11 as an outer periphery when viewed through first substrate 30 from a direction perpendicular to a surface of the first substrate 30. As illustrated in FIG. 2, the heater 20 is disposed at the same height as the ring resonator 10 in a direction perpendicular to the surface of the first substrate 30 (a thickness direction of the first substrate 30 (a vertical direction on the paper surface of FIG. 2)). The height described above may be different between the heater 20 and the ring resonator 10.

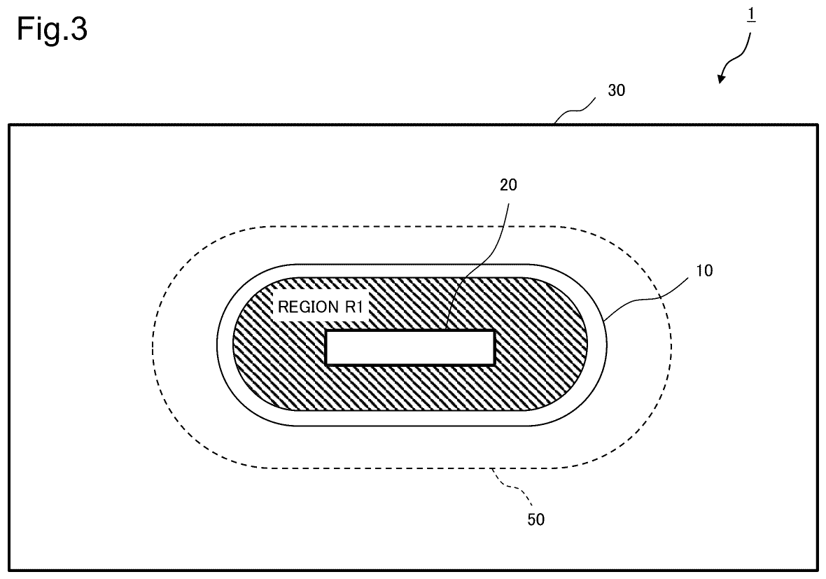

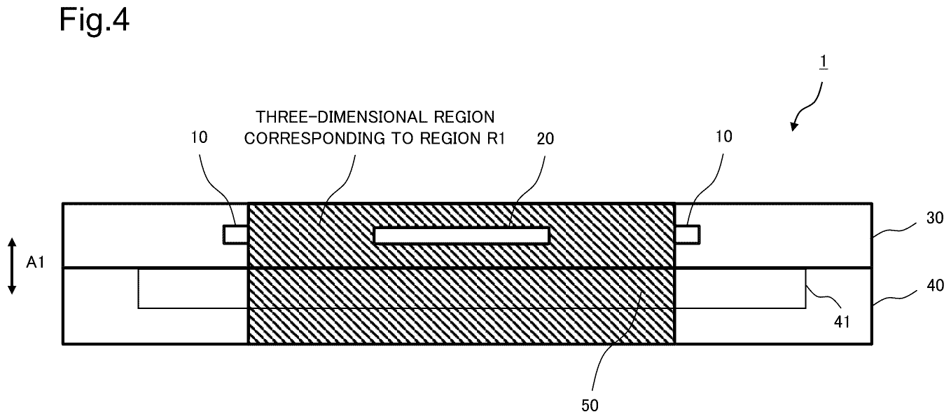

The position of the heater 20 will be described with reference to FIGS. 3 and 4. In FIG. 3, a first region R1 is added by hatching in FIG. 1. In FIG. 4, in the first substrate 30 and the second substrate 40, a three-dimensional region corresponding to the first region R1 is added by hatching in FIG. 2. A three-dimensional region corresponding to the first region R1 indicates a region where a figure extending the first region R1 in a direction perpendicular to the surface of the first substrate 30, the first substrate 30, and the second substrate 40 overlap each other. As illustrated in FIG. 3, in first region R1, a shape of the ring-shaped optical waveguide 11 when viewed through the first substrate 30 from a direction perpendicular to the surface of the first substrate 30 is defined as an outer periphery. In the example of FIG. 3, an inner periphery of the ring-shaped optical waveguide 11 is defined as an outer periphery of the first region R1, but an outer periphery of the ring-shaped optical waveguide may be defined as the outer periphery of the first region R1.

As illustrated in FIG. 4, the three-dimensional region corresponding to the first region R1 has a columnar shape whose bottom surface is defined by a shape of the ring-shaped optical waveguide 11 when viewed through the first substrate 30 from the direction perpendicular to the surface of the first substrate 30. In the example of FIG. 4, the three-dimensional region corresponding to the first region R1 is a region sandwiched between a part of one bottom surface of the first substrate 30 (upper surface in FIG. 4) and a part of the other bottom surface of the first substrate 30 (lower surface in FIG. 4). That is, in the example illustrated in FIGS. 1, 2, 3, and 4, a three-dimensional region corresponding to the first region R1 has a columnar shape with the two bottom surfaces of the first substrate 30, each of which has the shape of the ring-shaped optical waveguide 11 as its outer periphery, as its bottom surface.

As illustrated in FIGS. 2 and 4, a distance from a bottom surface of the first substrate 30 (for example, an upper surface in FIGS. 2 and 4) to the heater 20 is equal to a distance from the bottom surface of the first substrate 30 (for example, the upper surface in FIGS. 2 and 4) to the ring-shaped optical waveguide 11. However, the ring-shaped optical waveguide 11 and the heater 20 may be provided in such a way that these distances are different.

The heater 20 generates heat in accordance with power input from a drive circuit (not illustrated). Thus, the heater 20 heats the ring-shaped optical waveguide 11. Specifically, the heater 20 heats the first substrate 30 and the ring-shaped optical waveguide 11. In the example of FIGS. 1 and 3, the shape of the surface of the heater 20 when viewed through the first substrate 30 from the direction perpendicular to the surface of the first substrate 30 is rectangular, but may be a polygon larger than a rectangle, a circular arc, a circle, or an ellipse.

The heater 20 may be disposed at a position including a central portion in the first region having the optical waveguide 11 as an outer periphery. As illustrated in FIG. 3, the heater 20 is disposed at the center of a shaded region indicating the first region R1. More specifically, the heater 20 is disposed in the first substrate 30 on a straight line from the center of one bottom surface to the center of the other bottom surface of the first region R1. The heater 20 is not necessarily disposed at a position including the central portion in the first region.

The first substrate 30 is a plate-like substrate including at least quartz glass, for example. At least the ring resonator 10 and the heater 20 are attached to the first substrate 30. An optical waveguide different from the ring-shaped optical waveguide 11 or an electronic device may be further attached to the first substrate 30. The first substrate 30 is provided in such a way as to be stacked in the first direction with respect to the second substrate 40. In this description, the first direction indicates a vertical direction indicated by an arrow A1 in FIGS. 2 and 4.

The second substrate 40 is, for example, a plate-like substrate including at least silicon. The second substrate 40 is stacked in the first direction with respect to the first substrate 30. The second substrate 40 has a hole 41. The hole 41 is formed in a surface of the second substrate 40 in contact with the first substrate 30. As illustrated in FIGS. 2 and 4, the second substrate 40 adheres to the first substrate 30 via a region other than the region where the hole 41 is provided in the surface of the second substrate 40 facing the first substrate 30.

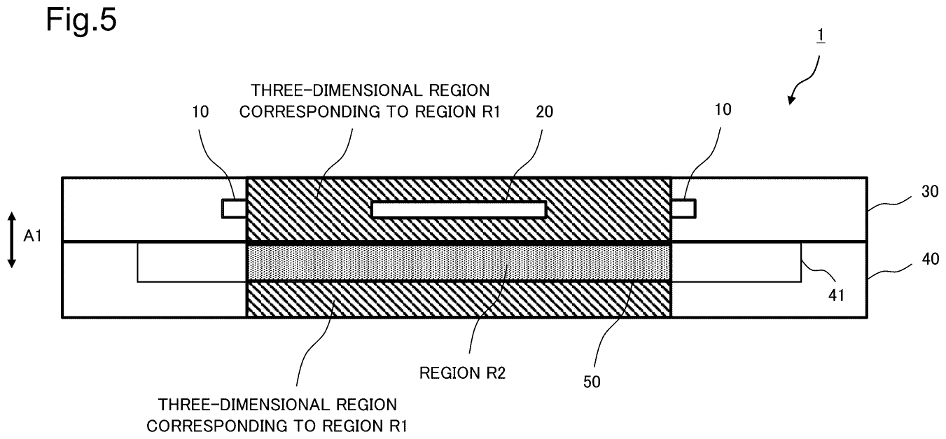

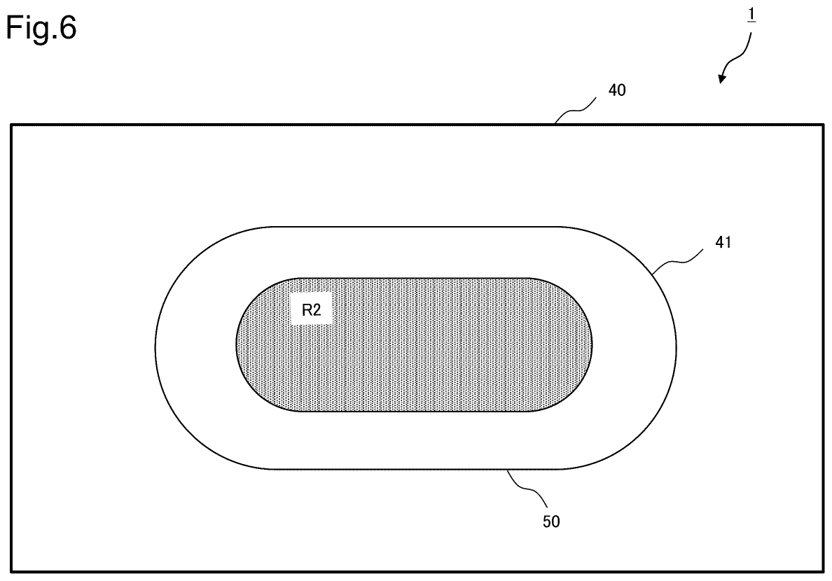

The gap 50 is a space inside a hole provided in a surface of the second substrate 40 facing the first substrate 30. The gap 50 is formed to include at least a region (a second region R2 to be described later) located between the first substrate 30 and the second substrate 40 in the first region R1. The gap 50 is filled with argon, for example. Details of the gap 50 will be described with reference to FIGS. 5 and 6.

FIG. 5 illustrates a part of the three-dimensional region corresponding to the first region R1 illustrated in FIG. 4 as a second region R2. The second region R2 is a three-dimensional region located between the first substrate 30 and the second substrate 40 in the three-dimensional region corresponding to the first region R1. FIG. 6 is a top view of the second substrate 40. As shown in FIG. 6, the second substrate 40 has the hole 41. The gap 50 is a space located inside the hole 41. At this time, the hole 41 is formed such that the gap 50 includes at least the second region R2.

Similarly to the three-dimensional region corresponding to the first region R1, the second region R2 has a bottom surface whose outer circumference is the shape of the ring-shaped optical waveguide 11. Therefore, similarly to the three-dimensional region corresponding to the first region R1, the second region R2 has a columnar shape having the same shape as the shape of the ring-shaped optical waveguide 11 as the bottom surface. Any distance between the two bottom surfaces in the second region R2 can be set.

As described above, the optical module 1 includes the ring resonator 10, the heater 20, the first substrate 30, the second substrate 40, and the gap 50. The ring resonator 10 has the ring-shaped optical waveguide 11 and is attached to the first substrate 30. The heater 20 is provided inside the first substrate 30 in the first region R1 having the optical waveguide 11 as an outer periphery when viewed through the first substrate 30 from a direction perpendicular to the surface of the first substrate 30, and heats the ring resonator 10. The second substrate 40 is stacked on the first substrate 30. The gap 50 is located between the first substrate 30 and the second substrate 40, and is formed in such a way that the first substrate 30 and the second substrate 40 are spaced away in the first region R1.

For example, in a case where the gap 50 is not formed and the first substrate 30 and the second substrate 40 are not spaced away from each other, the heat from the heater 20 is transferred to the second substrate 40 before being transferred to the ring-shaped optical waveguide 11. Therefore, the heat from heater 20 cannot be efficiently transmitted to the ring-shaped optical waveguide 11 (ring resonator structure).

On the other hand, as described above, the optical module 1 has the gap formed in such a way that the first substrate 30 and the second substrate 40 are spaced away from each other in the first region R1 when viewed through the first substrate 30 from the direction perpendicular to the surface of the first substrate 30. When viewed through the first substrate 30 from the direction perpendicular to the surface of the first substrate 30, the first region R1 has the shape of the optical waveguide 11 as the outer periphery, in such a way that the gap 50 is formed in a region of the first substrate 30 where the first region R1 is located. Therefore, the heat from the heater 20 is not transmitted to the second substrate 40 before being transmitted to the ring-shaped optical waveguide 11. As a result, the heat from the heater 20 can be efficiently transmitted to the ring-shaped optical waveguide (ring resonator structure). Thus, the optical module 1 can also suppress power consumption in the heater 20.

In the optical module 1, the heater 20 is disposed at a position including a central portion in the first region R1 having the optical waveguide 11 as an outer periphery. A typical heater that heats the optical waveguide may be provided near the optical waveguide to efficiently heat the optical waveguide. However, since the gap 50 is formed in the optical module 1, the heater 20 can already efficiently heat the optical waveguide, and thus, may be disposed at a position including the center in the first region R1 having the optical waveguide 11 as the outer periphery. This eliminates the need to provide the heater 20 near the optical waveguide, thereby improving the degree of freedom of the shape and position of the heater 20. As a result, in the optical module 1, arrangement locations of other optical components and electronic components can be more freely determined.

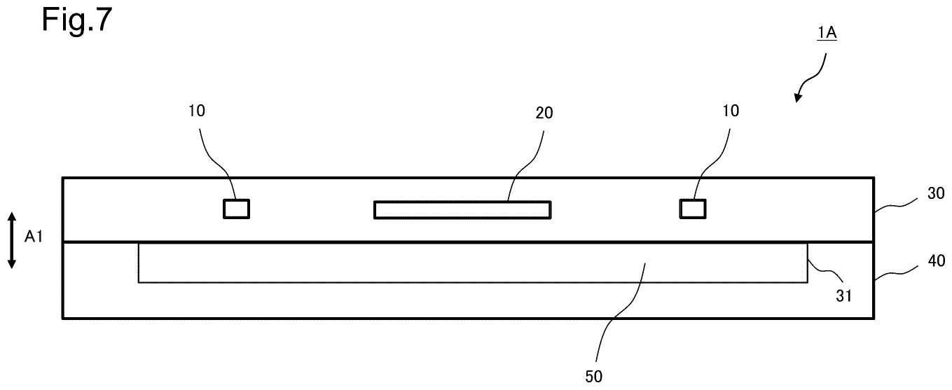

Next, an optical module 1A will be described. The optical module 1A is a first modification of the optical module 1. FIG. 7 is a diagram illustrating the optical module 1A. As illustrated in FIG. 7, similarly to the optical module 1, the optical module 1A includes a ring resonator 10, a heater 20, a first substrate 30, a second substrate 40, and a gap 50. On the other hand, in the optical module 1A, the second substrate 40 does not have the hole 41, and the first substrate 30 has a hole 31. In this case, the gap 50 is a space formed inside the hole 31 of the first substrate 30. In the optical module 1A, the first substrate 30 adheres to the second substrate 40 via a region other than the region provided with the hole 31 in the surface of the first substrate 30 facing the second substrate 40.

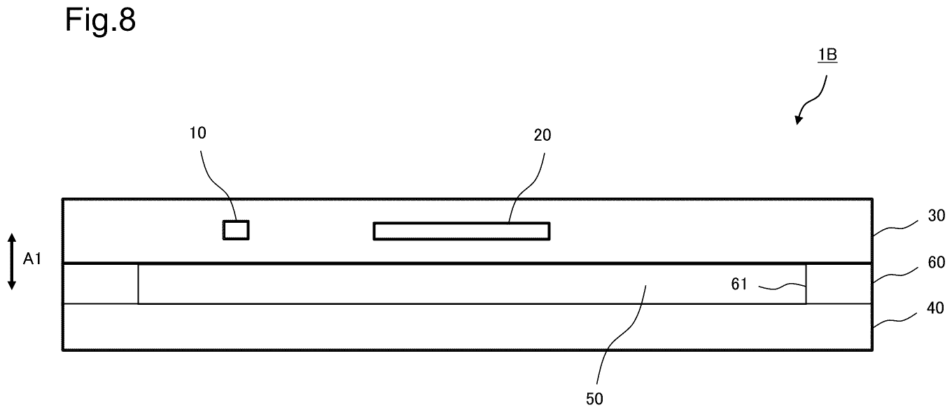

Next, an optical module 1B will be described. The optical module 1B is a second modification of the optical module 1. FIG. 8 is a diagram illustrating the optical module 1B. As illustrated in FIG. 8, similarly to the optical module 1, the optical module 1B includes a ring resonator 10, a heater 20, a first substrate 30, a second substrate 40, and a gap 50. The optical module 1B further includes a third substrate 60. The third substrate 60 is provided in such a way as to be stacked in a first direction with respect to the first substrate 30 and the second substrate 40. In this description, the first direction indicates a vertical direction indicated by an arrow A1 in FIG. 8. On the other hand, in the optical module 1B, the second substrate 40 does not have the hole 41, and the third substrate 60 has a hole 61. Therefore, the gap 50 is a space formed inside the hole 61 of the third substrate 60.

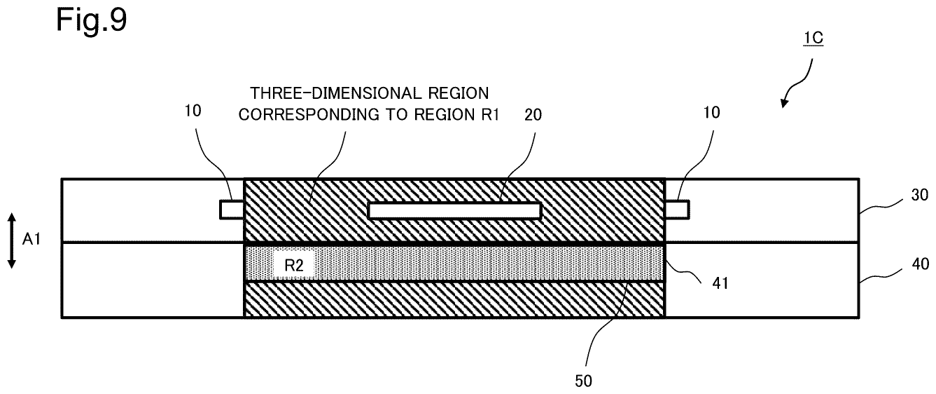

Next, an optical module 1C will be described. The optical module 1C is a third modification of the optical module 1. FIG. 9 is a diagram illustrating the optical module 1C. As illustrated in FIG. 9, similarly to the optical module 1, the optical module 1C includes a ring resonator 10, a heater 20, a first substrate 30, a second substrate 40, and a gap 50. In FIG. 9, similarly to FIG. 5, a first region R1 and a second region R2 are illustrated. In the description of the optical module 1, as illustrated in FIGS. 2 and 5, the gap 50 is illustrated to be larger than the second region R2. However, in the optical module 1C, as illustrated in FIG. 9, the gap 50 may have the same size as the second region R2.

### Second Example Embodiment

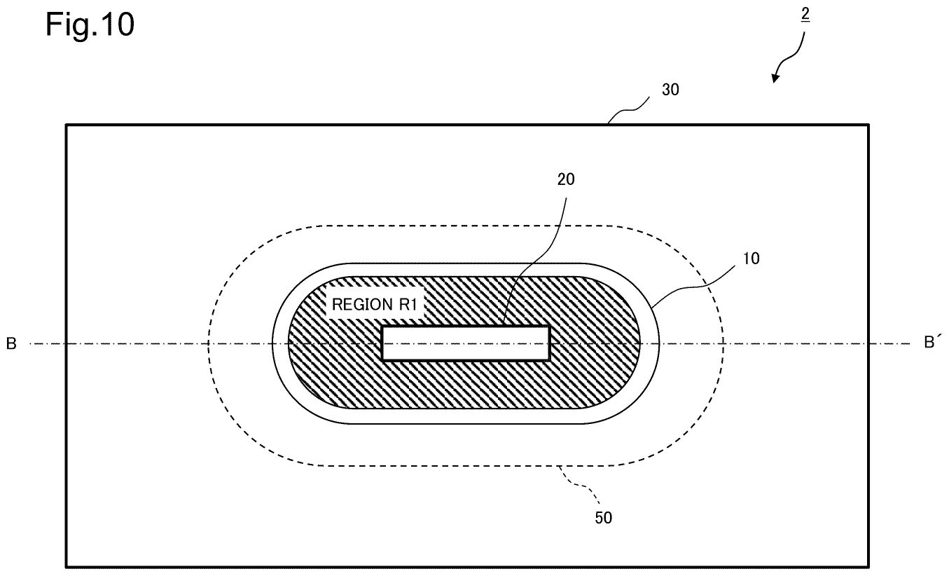

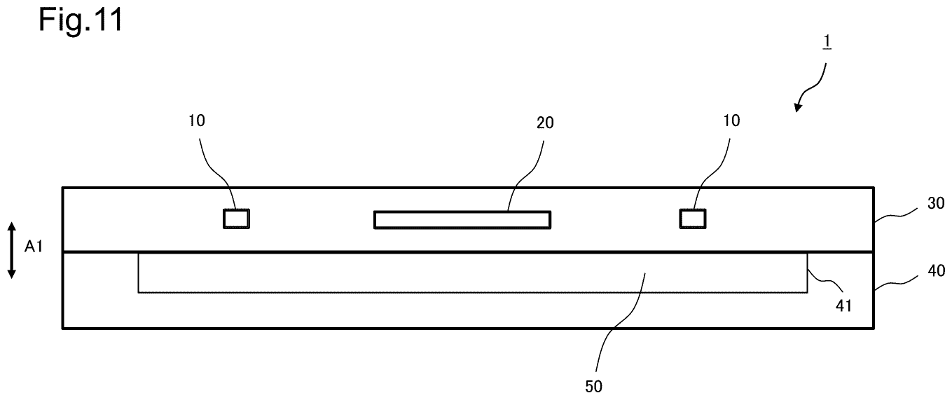

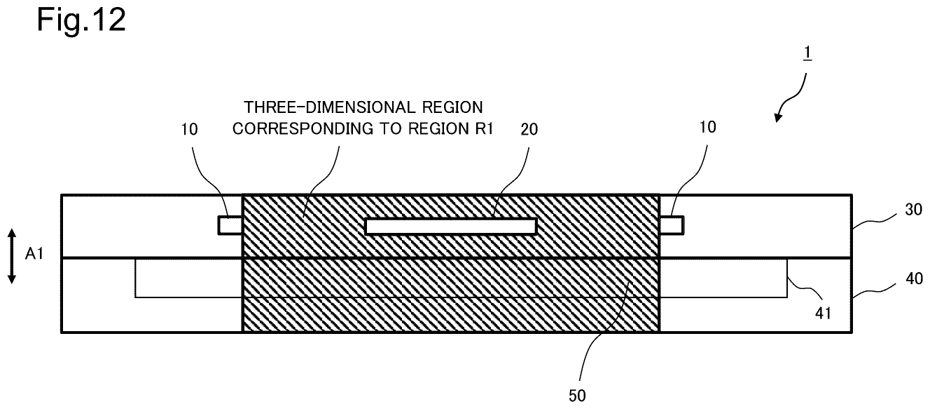

An optical module 2 according to a second example embodiment will be described with reference to FIG. 10. FIG. 10 is a block diagram illustrating a configuration example of the optical module 2. FIG. 11 is a cross-sectional view of the optical module 2. Specifically, FIG. 11 is a cross-sectional view of the optical module 2 taken along line B-B′ illustrated in FIG. 10. In FIG. 12, a three-dimensional region corresponding to the first region R1 is added to FIG. 11.

As illustrated in FIG. 10, the optical module 2 includes a ring resonator 10, a heater 20, a first substrate 30, and a gap 50. As illustrated in FIG. 11, the optical module 1 includes a ring resonator 10, a heater 20, a first substrate 30, a second substrate 40, and a gap 50.

The ring resonator 10 has a ring-shaped optical waveguide 11 and is attached to the first substrate 30. As illustrated in FIG. 10, the heater 20 is provided in the first substrate 30 in the first region R1 having the optical waveguide 11 as an outer periphery when viewed through the first substrate 30 from a direction perpendicular to a surface of the first substrate 30, and heats the ring resonator 10. The second substrate 40 is stacked on the first substrate 30. The gap 50 is located between the first substrate 30 and the second substrate 40, and is formed in such a way that the first substrate 30 and the second substrate 40 are spaced away in a three-dimensional region corresponding to the first region R1.

For example, in a case where the gap 50 is not formed and the first substrate 30 and the second substrate 40 are not spaced away from each other, the heat from the heater 20 is transferred to the second substrate 40 before being transferred to the ring-shaped optical waveguide 11. Therefore, the heat from heater 20 cannot be efficiently transmitted to the ring-shaped optical waveguide 11 (ring resonator structure).

On the other hand, as described above, the optical module 2 has the gap formed in such a way that the first substrate 30 and the second substrate 40 are spaced away from each other in the first region R1 when viewed through the first substrate 30 from the direction perpendicular to the surface of the first substrate 30. When viewed through the first substrate 30 from the direction perpendicular to the surface of the first substrate 30, the first region R1 has the shape of the optical waveguide 11 as the outer periphery, in such a way that the gap 50 is formed in a region of the first substrate 30 where the first region R1 is located. Therefore, the heat from the heater 20 is not transmitted to the second substrate 40 before being transmitted to the ring-shaped optical waveguide 11. As a result, the heat from the heater 20 can be efficiently transmitted to the ring-shaped optical waveguide (ring resonator structure). Thus, the optical module 2 can also suppress power consumption in the heater 20. Some or all of the above-described example embodiments may be described as the following supplementary notes, but are not limited to the following supplementary notes.

### Supplementary Note 1

An optical module including:
a first substrate;
a second substrate stacked on the first substrate;
a ring resonator having a ring-shaped optical waveguide and attached to the first substrate;
a heater that is provided inside the first substrate and heats the ring resonator in a first region having the optical waveguide as an outer periphery when viewed through the first substrate from a direction perpendicular to a surface of the first substrate; and
a gap located between the first substrate and the second substrate and formed in such a way that the first substrate and the second substrate are separated from each other in the first region.

### Supplementary Note 2

The optical module according to Supplementary Note 1, in which
the gap is a space inside a hole provided in a surface of the second substrate facing the first substrate, and
the second substrate adheres to the first substrate via a region other than a region provided with the hole in a surface of the second substrate facing the first substrate.

### Supplementary Note 3

The optical module according to Supplementary Note 1 or 2, in which the heater is disposed in a central portion in the first region.

### Supplementary Note 4

The optical module according to any one of Supplementary Notes 1 to 3, in which the gap is filled with argon.

### Supplementary Note 5

The optical module according to any one of Supplementary Notes 1 to 4, in which the first substrate includes at least quartz glass.

### Supplementary Note 6

The optical module according to any one of Supplementary Notes 1 to 5, in which the second substrate includes at least silicon.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

### REFERENCE SIGNS LIST

1, 1A, 1B, 1C, 2 optical module
10 ring resonator
11 optical waveguide
20 heater
30 first substrate
31 hole
40 second substrate
41 hole
50 gap
60 third substrate
61 hole
R1 first region
R2 second region

What is claimed is:

1. An optical module comprising:
a first substrate;
a second substrate stacked on the first substrate;
a ring resonator having a ring-shaped optical waveguide and attached to the first substrate;
a heater that is provided inside the first substrate and heats the ring resonator in a first region having the optical waveguide as an outer periphery when viewed through the first substrate from a direction perpendicular to a surface of the first substrate; and
a gap located between the first substrate and the second substrate and formed in such a way that the first substrate and the second substrate are spaced away from each other in the first region.

2. The optical module according to claim 1, wherein the gap is a space inside a hole provided in a surface of the second substrate facing the first substrate, and
the second substrate adheres to the first substrate via a region other than a region provided with the hole in a surface of the second substrate facing the first substrate.

3. The optical module according to claim 1, wherein the heater is disposed in a central portion in the first region.

4. The optical module according to claim 1, wherein the gap is filled with argon.

5. The optical module according to claim 1, wherein the first substrate includes at least quartz glass.

6. The optical module according to claim 1, wherein the second substrate includes at least silicon.
